(19) United States
(12) Patent Application Publication
(10) Pub. No.: US 2025/0363032 A1
(43) Pub. Date: Nov. 27, 2025

(54) SYSTEMS AND METHODS FOR ASSESSING DUPLICATE ARTIFICIAL INTELLIGENCE (AI) AGENTS BASED ON COMPLEXITY, PERSONALIZATION AND TRAINING

(71) Applicant: Affle (India) Limited, India, Gurugram (IN)

(72) Inventors: Anuj Khanna SOHUM, Singapore (SG); Charles Yong Jien FOONG, Templestowe (AU); Madhusudana RAMAKRISHNA, Singapore (SG)

(73) Assignee: Affle (India) Limited, India, Gurugram (IN)

(21) Appl. No.: 19/216,131

(22) Filed: May 22, 2025

(30) Foreign Application Priority Data
May 22, 2024 (IN) 202311079242

(51) Int. Cl. G06F 11/34

(52) U.S. Cl. CPC G06F 11/3466

(57) ABSTRACT

The present disclosure provides a system and method for assessing duplicate artificial intelligence (ai) agents based on complexity, personalization and training. The method includes receiving, by a duplicate agent assessment, Data associated with the plurality of AI agent and determining a complexity score for the AI agent. The method also includes computing a score for personalization level using a common usage threshold and computing a training similarity score by monitoring the allocation of decision-making capabilities and analyzing the overlap and convergence of training data. The method then generates a composite similarity score based on the computed complexity score, score for personalization level, and training similarity score; and compares the composite similarity score to a predefined threshold to generate a duplication assessment output.

### CROSS REFERENCE TO RELATED APPLICATIONS

This patent application claims priority to Indian Patent Application No. IN 202311079242, filed May 22, 2024, entitled “SYSTEMS AND METHODS FOR ASSESSING DUPLICATE ARTIFICIAL INTELLIGENCE (AI) AGENTS BASED ON COMPLEXITY, PERSONALIZATION AND TRAINING” and assigned to the assignee hereof. The disclosure of the prior application is considered part of and is incorporated by reference in this patent application.

### TECHNICAL FIELD

Embodiments of the present disclosure generally relate to artificial intelligence (AI) based systems and more particularly to systems and methods for assessing duplicate artificial intelligence (AI) agents based on complexity, personalization, and training.

### BACKGROUND

The advancement of artificial intelligence (AI) has ushered in an era of unprecedented innovation and automation across various industries. AI agents, which are virtual entities designed to perform specific tasks or provide services, have become integral to the functioning of numerous applications, from virtual assistants to complex decision-making algorithms. However, with the proliferation of AI agents, there has emerged a pressing need to address the challenges associated with the presence of duplicate agents within AI ecosystems.

The technology landscape has been grappling with the issue of duplicate AI agents, which can arise due to various reasons. One of the key challenges is assessing the complexity of these agents. AI agents come in a spectrum of complexity levels, from simple, rule-based systems to highly intricate neural networks. Determining the level of complexity is essential, as simpler agents are more susceptible to duplication, leading to an overabundance of redundant solutions and potential inefficiencies.

Hence, there is a need for improved methods to quantify and manage the complexity of AI agents, ensuring optimal diversity in the AI ecosystem.

Another critical concern is the personalization of AI agents. As AI technology evolves, there's a growing demand for tailored, personalized AI solutions. However, excessive personalization can lead to a proliferation of highly similar AI agents that cater to the same niche of user needs. This redundancy not only consumes resources but also poses challenges for system administrators and users who seek diverse AI options. Thus, there is a pressing need for innovative techniques to strike a balance between personalization and common usage, fostering diversity and efficiency within AI ecosystems.

Consequently, there is a need for improved systems and methods for assessing duplicate artificial intelligence (AI) agents based on complexity, personalization, and training.

### Objects of the Invention

Some of the objects of the present disclosure, which at least one embodiment herein satisfy, are listed herein below.

It is an object of the present subject matter to overcome the afore mentioned and other drawbacks existing in the prior art systems and methods.

It is a significant object of the present subject matter to design a system and method for assessing duplicate or near-duplicate artificial intelligence (AI) agents to maintain diversity, efficiency, and originality within AI ecosystems.

It is another object of the present subject matter to design and develop the system such that the system enables multi-factorial assessment of AI agents using a composite scoring mechanism that evaluates model complexity, personalization level, and training lineage.

It is another object of the present subject matter to design and develop the system to detect functional duplication among AI agents, even where superficial or structural differences exist.

It is yet another object of the present subject matter to design and develop the system that prevents resource wastage and system inefficiency caused by redundant AI agents performing overlapping or identical tasks.

It is even another object of the present subject matter is to design and develop the system to provide administrators and marketplace operators with a duplication likelihood score, similarity reports, and actionable deduplication suggestions to govern AI agent lifecycle effectively.

These and other objects and advantages of the present subject matter, will be apparent to a person skilled in the art after consideration of the following detailed description, taken into consideration with accompanied drawings in which preferred embodiments of the present subject matter are illustrated.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter.

In an embodiment, the present invention discloses a method for assessing duplication among plurality of artificial intelligence (AI) agents. The method includes receiving, by a duplicate agent assessment, data associated with the plurality of AI agent; determining a complexity score for each of the AI agents from the plurality of AI agents based on at least one of: diversity and cardinality of input data points handled by the AI agent, architectural complexity of the model, and extent of embedding utilization in decision-making; computing a score for personalization level for each of the AI agents from the plurality of AI agents using a common usage threshold, wherein the common usage threshold is determined based on extent of personal information provided during training and uniqueness of training data; computing a training similarity score for each of the AI agents from the plurality of AI agents by monitoring the allocation of decision-making capabilities from one AI agent to another and analyzing the overlap and convergence of training data, to detect instances of gradual duplication of replicated agent behavior; generating a composite similarity score for each of the AI agents from the plurality of AI agents based on the computed complexity score, score for personalization level, and training similarity score; and comparing the composite similarity score to a predefined threshold to generate a duplication assessment output.

In an aspect, the duplication assessment output comprising the composite similarity score that serves as an actionable metric to identify potential duplicate AI agents, and enables the system or an administrator to flag, review, or manage agents exceeding a predefined similarity threshold

In an aspect, determining the complexity score comprises model introspection to assess architectural novelty and parameter dispersion analyzing the cardinality of input datasets and the number of trainable parameters in the AI agent.

In an aspect, computing the score for personalization level comprises evaluating behavioral features such as tone of speech, response style, and multimodal interaction traits.

In an aspect, the method includes defining the predefined threshold for composite similarity score above which AI agents are marked as potential duplicates for manual or automated review.

In an aspect, the method includes triggering adaptive re-training or suppression of redundant AI agents based on duplication assessment output.

In another embodiment, the present invention discloses a system for assessing duplication among plurality of artificial intelligence (AI) agents, the system comprising: one or more processors; and a memory storing programmed instructions executable by the one or more processors, wherein the one or more processors execute the programmed instructions to: receive data associated with the plurality of AI agent; determine a complexity score for each of the AI agents from the plurality of AI agents based on at least one of: diversity and cardinality of input data points handled by the AI agent, architectural complexity of the model, and extent of embedding utilization in decision-making; compute a score for personalization level for each of the AI agents from the plurality of AI agents using a common usage threshold, wherein the common usage threshold is determined based on extent of personal information provided during training and uniqueness of training data; compute a training similarity score by monitoring the allocation of decision-making capabilities from one AI agent to another and analyzing the overlap and convergence of training data, to detect instances of gradual duplication of replicated agent behavior; generate a composite similarity score based on the computed complexity score, score for personalization level, and training similarity score; and compare the composite similarity score to a predefined threshold to generate a duplication assessment output

To further understand the characteristics and technical contents of the present subject matter, a description relating thereto will be made with reference to the accompanying drawings. However, the drawings are illustrative only but not used to limit the scope of the present subject matter.

Various objects, features, aspects, and advantages of the inventive subject matter will become more apparent from the following detailed description of preferred embodiments, along with the accompanying drawing figures in which numerals represent like components.

### BRIEF DESCRIPTION OF THE DRAWINGS

It is to be noted, however, that the appended drawings illustrate only typical embodiments of the present subject matter and are therefore not to be considered for limiting its scope, for the invention may admit to other equally effective embodiments. A detailed description is given with reference to the accompanying figures. In the figures, a reference number identifies the figure in which the reference number first appears. The same numbers are used throughout the figures to refer like features and components. Some embodiments of system or methods or structure in accordance with embodiments of the present subject matter are now described, by way of example, and with reference to the accompanying figures, in which

FIG. 1 illustrates an exemplary block diagram representation of a network architecture implementing a system for assessing duplicate artificial intelligence (AI) agents based on complexity, personalization, and training, in accordance with an embodiment of the present disclosure;

FIG. 2 illustrates an exemplary block diagram representation of a computer implemented system, such as those shown in FIG. 1, capable of assessing duplicate artificial intelligence (AI) agents based on complexity, personalization, and training, in accordance with an embodiment of the present disclosure;

FIG. 3 illustrates an exemplary flow diagram representation assessing duplicate artificial intelligence (AI) agents based on complexity, personalization, and training, in accordance with an embodiment of the present disclosure; and

FIG. 4 illustrates a flow chart of a method for assessing duplicate artificial intelligence (AI) agents based on complexity, personalization, and training, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is therefore intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. The appearance of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for assessing duplicate artificial intelligence (AI) agents based on complexity, personalization, and training.

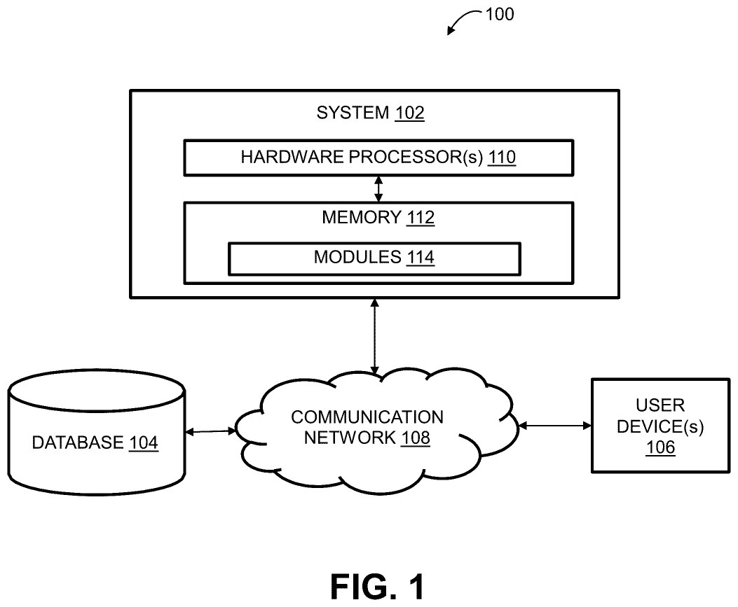

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

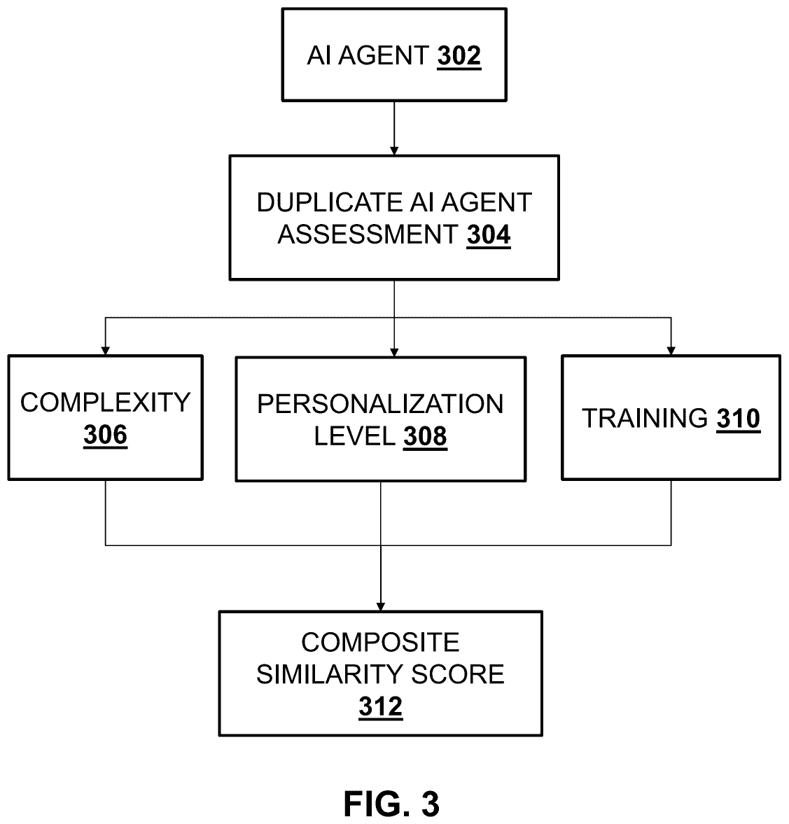

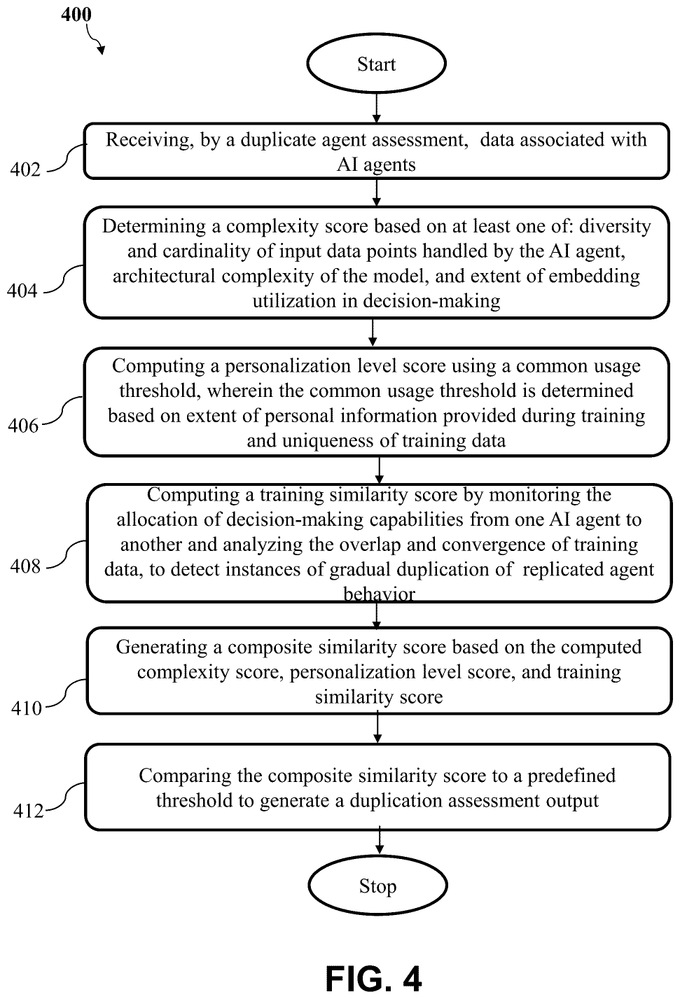

FIG. 1 illustrates an exemplary block diagram representation of a network architecture 100 implementing a system 102 for assessing duplicate artificial intelligence (AI) agents based on complexity, personalization, and training, in accordance with an embodiment of the present disclosure. According to FIG. 1, the network architecture 100 includes a system 102, a database 104, and one or more user devices 106. The one or more user devices 106 may be associated with one or more users, and communicatively coupled to the system 102 via a communication network 108. In an exemplary embodiment of the present disclosure, the user devices 106 may include a laptop computer, desktop computer, tablet computer, smartphone, wearable device, a digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, personal data, health data, lifestyle data, any other data, and combinations thereof. The database 104 may be any kind of databases/repositories such as, but are not limited to, relational database, dedicated database, dynamic database, monetized database, scalable database, cloud database, distributed database, any other database, and combination thereof. When deployed as a secure cloud-based service, the system 102 implements the assessment process (as depicted in the interaction flow of FIG. 3 and method steps of FIG. 4) ensuring robust security and data integrity. For example, the reception of data associated with AI agents (block 402) into the system 102 hosted in the cloud utilizes secure communication channels, such as Application Programming Interfaces (APIs) secured with HTTPS/TLS. These APIs would enforce strong authentication and authorization, potentially using standards like OAuth 2.0, to control access. AI agent data, including model architectures, training datasets, personalization attributes, and computed scores (complexity 306, personalization 308, training similarity 310, and composite similarity 312) stored in the database 104 or storage unit 204 within the cloud environment, is protected through mechanisms such as encryption at rest (e.g., AES-256) and fine-grained access controls. The plurality of modules 114 responsible for executing the assessment steps operate within a protected cloud infrastructure, such as a Virtual Private Cloud (VPC), to isolate resources and manage network traffic securely. Communication between distributed components of the system 102 or with external administrative interfaces further relies on secure protocols (e.g., TLS for internal communications, SSH for administrative access) to safeguard the confidentiality and integrity of the AI agent assessment lifecycle.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for assessing duplicate artificial intelligence (AI) agents based on complexity, personalization, and training. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for assessing duplicate artificial intelligence (AI) agents based on complexity, personalization, and training. Execution of the machine-readable program instructions by the hardware processor 110 may enable the proposed system 102 to assess duplicate artificial intelligence (AI) agents based on complexity, personalization, and training. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may assess duplicate artificial intelligence (AI) agents based on complexity, personalization, and training.

In an exemplary embodiment, the system 102 may distinguish between simple and complex AI agents. For instance, an AI agent tasked with finding the suburb of a workplace may generate numerous similar solutions, potentially leading to an abundance of duplicate matches. To gauge an agent's complexity, a scoring system is employed, considering a combination of various data points and their cardinality. The score also incorporates the complexity of the model and the utilization of embeddings.

In an exemplary embodiment, the system 102 may address the issue of personalization level 308 within AI agents. The personalization level 308 assesses whether an AI agent provides generic responses or tailored, personalized solutions. For instance, when the objective is to solve generic tasks like Tic-Tac-Toe, duplicate agents may emerge. To mitigate this, a framework defines a common usage threshold based on the extent of personal information provided and the uniqueness of data used for training. A scoring mechanism leverages these values to assess the overall personalization of the AI agent.

In an exemplary embodiment, the system 102 may recognize the significance of an AI agent's training level. It's crucial to monitor training levels to detect potential instances of one agent gradually copying another. This becomes particularly pertinent when there is an attempt to store and replicate an existing agent. The system leverages the allocation of decision-making capabilities from one agent to train another, potentially leading to rapid duplication. A similarity score based on the training data is used to ascertain the degree of resemblance between agents. As more data accumulates, converging on a personalized agent of similar complexity signals the gradual replication of an agent.

The system 102 uses the scores from the complexity 306, personalization level 308 and the training 310 to generate a composite score 312 that reflects the degree of resemblance between agents.

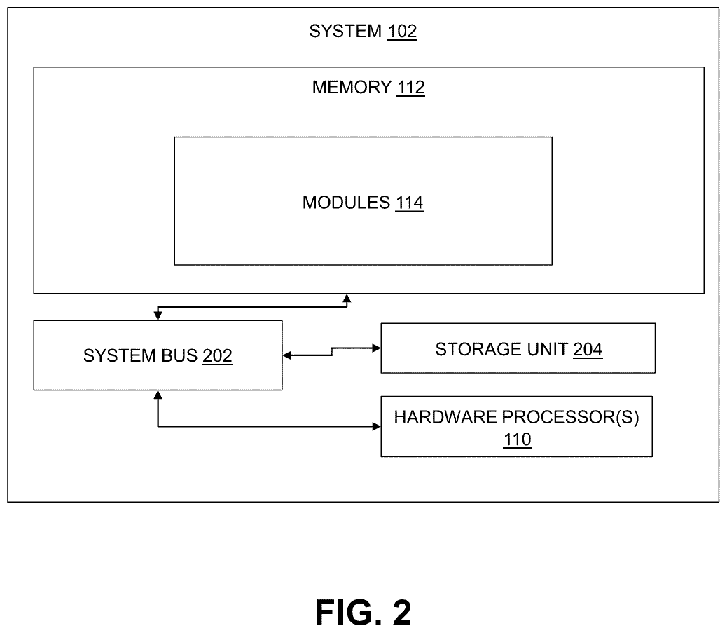

FIG. 2 illustrates an exemplary block diagram representation of a computer implemented system 102, such as those shown in FIG. 1, capable of assessing duplicate artificial intelligence (AI) agents based on complexity, personalization level, and training, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to, data points, personal information, similarity score any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

In an exemplary embodiment, the plurality of modules 114 may assess duplicate artificial intelligence (AI) agents based on complexity, personalization level, and training.

In an exemplary embodiment, the plurality of modules 114 may distinguish between simple and complex AI agents (not shown). For instance, an AI agent tasked with finding the suburb of a workplace may generate numerous similar solutions, potentially leading to an abundance of duplicate matches. To gauge an agent's complexity, a scoring system is employed, considering a combination of various data points and their cardinality. The score also incorporates the complexity of the model and the utilization of embeddings.

In an exemplary embodiment, the plurality of modules 114 may address the issue of personalization level within AI agents (not shown). For instance, when the objective is to solve generic tasks like Tic-Tac-Toe, duplicate agents may emerge. To mitigate this, a framework defines a common usage threshold based on the extent of personal information provided and the uniqueness of data used for training. A scoring mechanism leverages these values to assess the overall personalization of the AI agent.

In an exemplary embodiment, the plurality of modules 114 may recognize the significance of an AI agent's training level. It's crucial to monitor training levels to detect potential instances of one agent gradually copying another. This becomes particularly pertinent when there is an attempt to store and replicate an existing agent. The system leverages the allocation of decision-making capabilities from one agent to train another, potentially leading to rapid duplication. A similarity score based on the training data is used to ascertain the degree of resemblance between agents. As more data accumulates, converging on a personalized agent of similar complexity signals the gradual replication of an agent.

FIG. 3 illustrates an exemplary flow diagram representation of assessing duplicate artificial intelligence (AI) agents based on complexity, personalization, and training, in accordance with an embodiment of the present disclosure. The system 102 employs a multifaceted approach to assess potential duplication among AI agents by duplicate AI agents assessment 304, involving the assessment of complexity 306 (simple versus complex), personalization level 308 (personal versus common), and the amount of training 310 an AI agent 302 has undergone. In determining the scale of simplicity versus complexity, the system recognizes that AI agents 302 addressing straightforward tasks, such as locating a workplace's suburb, may generate a multitude of similar solutions, potentially leading to duplicate matches. To gauge an agent's complexity, a scoring mechanism is devised, drawing from a variety of data points and their cardinality. Additionally, the model's complexity and embeddings are considered in this assessment. Personalization level 308 is another key aspect, wherein the system acknowledges that generic tasks, like playing Tic-Tac-Toe, may result in duplicate agents. To mitigate this, a common usage threshold is defined, contingent upon the extent of personal information supplied and the uniqueness of data used for training. These factors collectively contribute to the overall personalization score of the AI agent 302. The amount of training the AI agent 302 has undergone is a critical factor in detecting gradual duplication. This becomes vital when an agent endeavors to replicate another, particularly with the involvement of a controller. In such cases, the system monitors the allocation of decision-making capabilities from one agent to train another, potentially leading to swift duplication. Based on the assessment of complexity, personalization, and training, a composite similarity score is generated. The composite similarity score helps to ascertain the degree of resemblance between agents. If data accumulates and converges on an agent that is personalized and complex, it may signal the gradual replication of an agent.

In an exemplary embodiment, testing of the agent is not limited to textual responses but also voice, 3d objects/person, mannerisms, behaviors, style, dress and other information that can be tested and compared.

In an embodiment, the duplicate agent assessment 304 concurrently evaluates three distinct characteristics such as complexity (306), personalization level (308), and training (310).

FIG. 4 illustrates a flow chart of a method for assessing duplicate artificial intelligence (AI) agents based on complexity, personalization, and training, in accordance with an embodiment of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved.

At block 402, a duplicate agent assessment 302 receives data associated with AI agent. In the context of the present disclosure, data associated with AI agent (AI agent data) refers to the complete set of information associated with the design, training, personalization, and behavior of an artificial intelligence (AI) agent. This includes, but is not limited to, model architecture details such as the type of model, number of layers, parameter count, and internal configuration; training data history comprising datasets, annotations, and sources used during pre-training or fine-tuning; and personalization attributes derived from user-specific data, contextual interactions, or domain-specific adaptation. AI agent data further encompasses inference logs capturing input-output behavior, response timing, and decision paths, as well as embedding vectors generated and used for semantic representation and decision-making. In cases where the AI agent operates through a multimodal interface, AI agent data may also include voice patterns, visual features, behavioral styles, and avatar-based characteristics. Additionally, deployment metadata such as update history, usage frequency, interaction domains, and user feedback logs may be included. This comprehensive dataset forms the basis for assessing agent complexity, personalization level, and training similarity in order to detect potential duplication or redundancy.

At block 404, complexity score 306 is determined based on at least one of: diversity and cardinality of input data points handled by the AI agent, architectural complexity of the model, and extent of embedding utilization in decision-making. At block 406, a score for personalization level (308) is computed using a common usage threshold, wherein the common usage threshold is determined based on the extent of personal information provided during training and uniqueness of training data. At block 408, a training similarity score (310) is computed by monitoring the allocation of decision-making capabilities from one AI agent to another and analyzing the overlap and convergence of training data, to detect instances of gradual duplication of replicated agent behavior. At block 410, a composite similarity score (312) is generated based on the computed complexity score, score for personalization level, and training similarity score. At block 412, the composite similarity score (312) is compared to a predefined threshold to generate a duplication assessment output.

In an embodiment, the duplication assessment output comprising the composite similarity score that serves as an actionable metric to identify potential duplicate AI agents, and enables the system or an administrator to flag, review, or manage agents exceeding a predefined similarity threshold.

In an embodiment, determining the complexity score includes model introspection to assess architectural novelty and parameter dispersion analyzing the cardinality of input datasets and the number of trainable parameters in the AI agent.

In an embodiment, computing the personalization score comprises evaluating behavioral features such as tone of speech, response style, and multimodal interaction traits.

In an embodiment, the method 400 further includes defining the predefined threshold for composite similarity score above which AI agents are marked as potential duplicates for manual or automated review.

In an embodiment, the method 400 further includes triggering adaptive re-training or suppression of redundant AI agents based on duplication assessment output.

### Exemplary Assessment of Duplicate AI Agents Based on Complexity, Personalization, and Training:

Consider a scenario within an AI-powered mobile app designed for answering user queries and providing recommendations. This app features a chatbot that can assist users with a wide range of tasks, from suggesting nearby restaurants to helping with travel bookings. In this context, the system is responsible for evaluating the AI agents 302 operating within the app. These AI agents 302 are tasked with addressing user queries and providing recommendations, and over time, the system aims to ensure the quality and diversity of responses. First, the system examines the complexity 306 of these AI agents. For instance, if a user poses a query as simple as, “Find me a coffee shop nearby,” several AI agents might generate similar responses. This simple task can lead to duplicate matches, as multiple agents provide indistinguishable answers. To assess the complexity, the system employs a scoring mechanism that considers various data points, such as the types of queries handled, the diversity of responses, and the model's intricacy. It also considers embeddings used for language processing. By doing so, the system can gauge the complexity of each AI agent. Next, the system focuses on the personalization level 308 of the AI agents 302. For generic queries like, “Play a game of Tic-Tac-Toe,” the system acknowledges that duplicate agents may emerge, as the responses tend to be uniform. To address this, the system establishes a common usage threshold. It factors in the personal information provided by users, such as preferences and past interactions, as well as the uniqueness of the data used for the AI agent training 310. These values collectively contribute to an overall personalization score for each agent. If the AI agent 302 consistently provides generic responses, its personalization level 308 would be lower compared to agents that tailor their responses to individual user preferences. Furthermore, the system keeps a close watch on the amount of training 310 an AI agent 302 undergoes. This is crucial, as some agents may attempt to replicate another agent slowly over time, potentially with the influence of a central controller. For instance, if an AI agent transfers all its decision-making abilities to train a new agent, a duplicate agent could be trained swiftly. For example, when one chatbot agent (Agent A) starts to perform very similar to another established chatbot agent (Agent B), over time, especially after updates or by transferring its decision-making capabilities to train a new agent. The system employs the training level score based on the trained information to identify such gradual duplication. As more data is collected and the training converges on an agent that exhibits both personalization and complexity, the system detects the gradual replication. By systematically assessing these factors, the system determines composite similarity scores for each AI agent. These composite similarity scores consider both the inherent complexity and the level of training an agent has undergone. Agents with composite similarity scores may be flagged as potential duplicates or candidates for further improvement. In this way, the system ensures the quality and diversity of AI agents within the app, enhancing the user experience and the app's overall efficiency.

### Exemplary Scenario 1:

The system 102 may possess the capability to assess duplicate artificial intelligence (AI) agents based on complexity, personalization, and training. The system 102 excels in evaluating duplicate artificial intelligence (AI) agents by considering complexity, personalization, and training levels. The marketplace relies on AI agents 302 to assist customers with product recommendations and inquiries. To ensure the distinctiveness of these AI agents 302, the system begins by assessing their complexity 306. For instance, when customers seek product recommendations, the system gauges the complexity of AI responses by considering diverse data points, including the variety of customer queries, the intricacy of AI models, and the complexity of language models and embeddings used for generating responses. This evaluation prevents the AI agents 302 from providing similar responses to customers, enhancing the marketplace's overall user experience.

Furthermore, the system evaluates personalization level 308, understanding that certain generic queries may yield similar responses. It assesses the extent of personal data from customers and the uniqueness of training data, enabling the system to assign personalization scores to each AI agent 302. The AI gents 302 delivering highly personalized recommendations receive higher scores, ensuring that customers receive tailored and relevant suggestions. The system also monitors the training levels of AI agents 302 to detect potential gradual duplication efforts. It scrutinizes the distribution of decision-making capabilities during training 310 and identifies convergence toward agents characterized by both personalization and complexity. This meticulous assessment results in composite similarity scores 312 for each AI agent, enabling the marketplace to provide customers with distinct, personalized, and high-quality AI-driven shopping experiences.

### Exemplary Scenario 2:

Consider a large-scale online education platform that relies on artificial intelligence (AI) agents to provide personalized tutoring and support to students. In this scenario, the system 102 demonstrates its proficiency in assessing duplicate AI agents 302 based on complexity, personalization, and training levels to ensure a high-quality and tailored learning experience for each student. As students interact with AI tutors to seek assistance with various subjects, the system initiates its assessment by analyzing the complexity of the AI responses. For example, when a student poses a math problem, multiple AI tutors may offer similar solutions. To prevent redundancy and enhance the educational experience, the system utilizes a complexity 306 scoring mechanism. It evaluates the diversity of queries handled by AI tutors, the intricacy of their responses, and the complexity of the AI models and embeddings used for subject-specific guidance. In the realm of education, personalization level 308 is crucial to cater to students' unique learning needs. However, generic queries such as “Explain the Pythagorean theorem” may lead to uniform responses. To address this, the system establishes a personalization threshold. It assesses the volume of personal information provided by students, including their learning history, preferred subjects, and past interactions with AI tutors. The uniqueness of the training 310 data used to refine AI tutors' capabilities is also considered. This combined data influences the personalization score for each AI tutor, ensuring that highly personalized and individualized learning guidance receives recognition. The system vigilantly monitors the training levels of AI tutors, especially to identify any gradual replication attempts. For instance, if one AI tutor seeks to mimic the capabilities of another, the system closely observes the training process. If a significant portion of one tutor's knowledge is used to train a new tutor, it may result in rapid duplication. To detect this, the system employs a composite similarity score 312 based on the trained information. It watches how the training data accumulates and whether it converges on an AI tutor characterized by both personalization and complexity. Such convergence indicates the gradual replication of the tutor. By employing these meticulous assessments, the system assigns composite similarity score to each AI tutor on the education platform. These scores take into consideration the complexity of the tutor's responses, the level of personalization they offer, and the extent of their training. Tutors with high composite similarity score may be subject to further scrutiny or adjustments, ensuring that students receive tailored, unique, and highly effective AI-driven learning experiences.

For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide systems and methods for assessing duplicate artificial intelligence (AI) agents based on complexity, personalization, and training. The present disclosure assesses duplicate artificial intelligence (AI) agents based on complexity, personalization, and training. The present disclosure distinguishes between simple and complex AI agents. For instance, an AI agent tasked with finding the suburb of a workplace may generate numerous similar solutions, potentially leading to an abundance of duplicate matches. To gauge an agent's complexity, a scoring system is employed, considering a combination of various data points and their cardinality. The complexity score also incorporates the complexity of the model and the utilization of embeddings. Further, the present disclosure addresses the issue of personalization level within AI agents. For instance, when the objective is to solve generic tasks like Tic-Tac-Toe, duplicate agents may emerge. To mitigate this, a framework defines a common usage threshold based on the extent of personal information provided and the uniqueness of data used for training. A scoring mechanism leverages these values to assess the overall personalization of the AI agent. Additionally, the present disclosure recognizes the significance of an AI agent's training level. It's crucial to monitor training levels to detect potential instances of one agent gradually copying another. This becomes particularly pertinent when there is an attempt to store and replicate an existing agent. The system leverages the allocation of decision-making capabilities from one agent to train another, potentially leading to rapid duplication. A similarity score based on the training data is used to ascertain the degree of resemblance between agents. As more data accumulates, converging on a personalized agent of similar complexity signals the gradual replication of an agent.

The embodiments in the present disclosure address the critical challenge of duplicate or near-duplicate AI agents in AI ecosystems. By assessing agents based on complexity, personalization, and training lineage, it reduces redundancy, optimizes resource usage, promotes diversity in AI behavior, and simplifies management. This ensures efficient deployment of unique, high-value agents, enhancing both system performance and user experience. This includes instances where one agent is incrementally trained or evolved to mimic another, rather than being an overt copy. In doing so, the invention provides a robust defence against both simple and functionally equivalent but superficially distinct AI agents.

Importantly, actionable composite similarity score allows the system or administrators to flag, review, and manage agents exceeding predefined duplication thresholds. The composite similarity score enables proactive curation of the AI ecosystem, ensuring the quality, originality, and functional diversity of deployed AI agents.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

We claim:

1. A method for assessing duplication among plurality of artificial intelligence (AI) agents, the method comprising:
receiving, by a duplicate agent assessment, data associated with the plurality of AI agents;
determining a complexity score for each of the AI agents from the plurality of AI agents based on at least one of:
diversity and cardinality of input data points handled by the AI agent, architectural complexity of the model, and extent of embedding utilization in decision-making;
computing a score for personalization level for each of the AI agents from the plurality of AI agents using a common usage threshold, wherein the common usage threshold is determined based on extent of personal information provided during training and uniqueness of training data;
computing a training similarity score for each of the AI agents from the plurality of AI agents by monitoring the allocation of decision-making capabilities from one AI agent to another and analyzing the overlap and convergence of training data;
generating a composite similarity score based on the computed complexity score, score for personalization level, and training similarity score; and
comparing the composite similarity score to a predefined threshold to generate a duplication assessment output.

2. The method as claimed in claim 1, wherein the duplication assessment output comprising the composite similarity score that serves as an actionable metric to identify potential duplicate AI agents, and enables the system or an administrator to flag, review, or manage agents exceeding a predefined similarity threshold.

3. The method as claimed in claim 1, wherein determining the complexity score comprises model introspection to assess architectural novelty and parameter dispersion analyzing the cardinality of input datasets and the number of trainable parameters in the AI agent.

4. The method as claimed in claim 1, wherein computing the personalization score comprises evaluating behavioral features such as tone of speech, response style, and multimodal interaction traits.

5. The method as claimed in claim 1, further comprising defining the predefined threshold for composite similarity score above which AI agents are marked as potential duplicates for manual or automated review.

6. The method as claimed in claim 1, further comprising triggering adaptive re-training or suppression of redundant AI agents based on duplication assessment output.

7. A system for assessing duplication among plurality of artificial intelligence (AI) agents, the system comprising:
one or more processors; and
a memory storing programmed instructions executable by the one or more processors, wherein the one or more processors execute the programmed instructions to:
receive data associated with plurality of AI agents;
determine a complexity score for each of the AI agents from the plurality of AI agents based on at least one of:
diversity and cardinality of input data points handled by the AI agent, architectural complexity of the model, and extent of embedding utilization in decision-making;
compute a score for personalization level for each of the AI agents from the plurality of AI agents using a common usage threshold, wherein the common usage threshold is determined based on extent of personal information provided during training and uniqueness of training data;
compute a training similarity score for each of the AI agents from the plurality of AI agents by monitoring the allocation of decision-making capabilities from one AI agent to another and analyzing the overlap and convergence of training;
generate a composite similarity score based on the computed complexity score, score for personalization level, and training similarity score; and
compare the composite similarity score to a predefined threshold to generate a duplication assessment output.

8. The system as claimed in claim 7, wherein the duplication assessment output comprising the composite similarity score that serves as an actionable metric to identify potential duplicate AI agents, and enables the system or an administrator to flag, review, or manage agents exceeding a predefined similarity threshold.

9. The system as claimed in claim 7, wherein determining the complexity score comprises model introspection to assess architectural novelty and parameter dispersion analyzing the cardinality of input datasets and the number of trainable parameters in the AI agent.

10. The system as claimed in claim 7, wherein computing the personalization score comprises evaluating behavioral features such as tone of speech, response style, and multimodal interaction traits.

11. The system as claimed in claim 7, wherein the one or more processors (110) are further configured to define the predefined threshold for composite similarity score above which AI agents are marked as potential duplicates for manual or automated review.

12. The system as claimed in claim 7, wherein the one or more processors (110) are further configured to trigger adaptive re-training or suppression of redundant AI agents based on duplication assessment output.

13. A non-transitory machine-readable medium including data, which when used by a system assessing duplication among plurality of artificial intelligence (AI) agents, causes the system to perform instructions that cause the system to perform operations comprising
receiving, by a duplicate agent assessment, data associated with the plurality of AI agents;
determining a complexity score for each of the AI agents from the plurality of AI agents based on at least one of:
diversity and cardinality of input data points handled by the AI agent, architectural complexity of the model, and extent of embedding utilization in decision-making;
computing a score for personalization level for each of the AI agents from the plurality of AI agents using a common usage threshold, wherein the common usage threshold is determined based on extent of personal information provided during training and uniqueness of training data;
computing a training similarity score for each of the AI agents from the plurality of AI agents by monitoring the allocation of decision-making capabilities from one AI agent to another and analyzing the overlap and convergence of training data;
generating a composite similarity score based on the computed complexity score, score for personalization level, and training similarity score; and
comparing the composite similarity score to a predefined threshold to generate a duplication assessment output.
